(19) United States
(12) Patent Application Publication
(10) Pub. No.: US 2026/0204585 A1
(43) Pub. Date: Jul. 16, 2026

(54) NEGATIVE ELECTRODE

(71) Applicant: TOYOTA JIDOSHA KABUSHIKI KAISHA, Toyota-shi (JP)

(72) Inventor: Shinichiro ITO, Kosai-shi (JP)

(73) Assignee: TOYOTA JIDOSHA KABUSHIKI KAISHA, Toyota-shi (JP)

(21) Appl. No.: 19/405,851

(22) Filed: Dec. 2, 2025

(30) Foreign Application Priority Data
Jan. 16, 2025 (JP) 2025-005984

(51) Int. Cl. H01M 4/62; H01M 4/02; H01M 4/36

(52) U.S. Cl. CPC H01M 4/628; H01M 4/366; H01M 2004/027

(57) ABSTRACT

A negative electrode for a secondary battery comprising a negative electrode current collector and a negative electrode mixture layer laminated on the negative electrode current collector and containing an active material, the negative electrode current collector comprising: a first layer; and a second layer laminated so as to cover a layer surface of the first layer and a side surface of the first layer, wherein in the first layer, the longitudinal direction of the active material contained in the first layer is oriented so as to face the thickness direction of the negative electrode current collector, and the second layer has a higher peel strength than that of the first layer.

### CROSS-REFERENCE TO RELATED APPLICATION

This application claims priority to Japanese Patent Application No. 2025-005984 filed on Jan. 16, 2025. The disclosure of the above-identified application, including the specification, drawings, and claims, is incorporated by reference herein in its entirety.

### BACKGROUND

### 1. Technical Field

The present disclosure relates to a negative electrode of a secondary battery.

### 2. Description of Related Art

Japanese Unexamined Patent Application Publication No. 2015-138644 (JP 2015-138644 A) discloses that the degree of orientation of a surface layer of a negative electrode active material layer is 0.01% or more and 0.4% or less, and the degree of orientation of a layer on a negative electrode current collector foil is 0.5% or less.

Japanese Unexamined Patent Application Publication No. 2014-107182 (JP 2014-107182 A) discloses that a layer in which the concentration of a binder on the side of a current collector foil is higher than the concentration of a binder on the opposite side of the current collector foil is included.
Japanese Unexamined Patent Application Publication No. 2015-138730 (JP 2015-138730 A) discloses that a first positive electrode active material and a layer around the first positive electrode active material are provided, and a second positive electrode active material has a greater basis weight.

### SUMMARY

In the conventional negative electrode active material layer, peeling and cracking of the electrode surface due to expansion and contraction during durability charging and discharging occur due to stress caused by a load in the process.

Therefore, an object of the present disclosure is to provide a negative electrode in which peeling or cracking is less likely to occur.

An aspect of the present application provides a negative electrode for a secondary battery, the negative electrode including a negative electrode current collector and a negative electrode mixture layer laminated on the negative electrode current collector and containing an active material, the negative electrode including:
a first layer; and
a second layer laminated so as to cover a layer surface of the first layer and a side surface of the first layer, in which:
the first layer is oriented such that a longitudinal direction of the active material contained in the first layer is directed in a thickness direction of the negative electrode current collector; and
the second layer has a higher peel strength than that of the first layer.

In the negative electrode according to the above aspect, the second layer may be oriented such that a longitudinal direction of the active material contained in the second layer is directed in a direction intersecting the thickness direction of the negative electrode current collector.

In the negative electrode according to the above aspect, the second layer may contain a binder in an amount less than that of the first layer by 25% or more.

According to the present disclosure, it is possible to maintain the diffusibility of lithium ions, and to suppress peeling due to stress during pressing, handling, etc. in the process and cracking of the electrode surface due to expansion and contraction during durability charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a layer configuration of a secondary battery 10;

FIG. 2 is a diagram for explaining a configuration of a negative electrode 20 according to Embodiment 1; and

FIG. 3 is a diagram for explaining a configuration of the negative electrode 30 according to Embodiment 2.

### DETAILED DESCRIPTION OF EMBODIMENTS

### Nonaqueous Electrolyte Secondary Battery

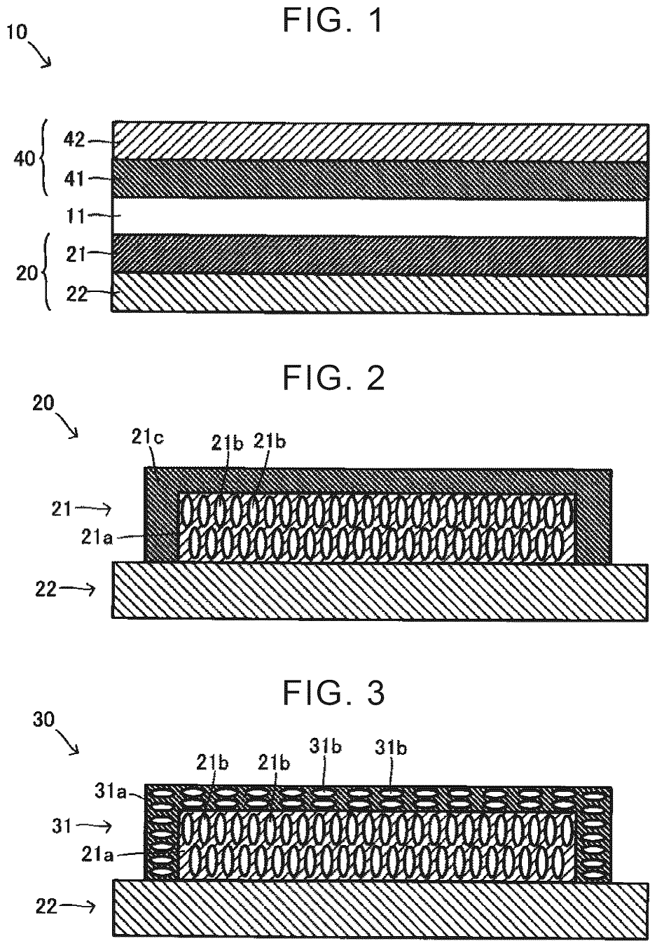

FIG. 1 is a schematic diagram illustrating an example of a configuration of a nonaqueous electrolyte secondary battery 10 (sometimes referred to as a “secondary battery 10”) according to one embodiment. The secondary battery 10 shown in FIG. 1 is a lithium ion secondary battery, and is configured such that the negative electrode 20 and the positive electrode 40 are laminated with a separator 11 interposed therebetween, and are enclosed in an outer package together with a nonaqueous electrolyte.

### Negative Electrode (Form Example 1)

FIG. 2 is a schematic cross-sectional view showing an example of the configuration of the negative electrode 20 according to Embodiment 1. As can be seen from FIG. 2, the negative electrode 20 includes a negative electrode mixture layer 21 and a negative electrode current collector 22. A separator 11 is laminated on one surface side of the negative electrode mixture layer 21, and a negative electrode current collector 22 is laminated on the other surface side.

The negative electrode current collector 22 is laminated on the negative electrode mixture layer 21 to collect current from the negative electrode mixture layer 21. In this embodiment, the negative electrode current collector 22 is in the form of a foil, and can be made of, for example, stainless steel, copper, nickel, carbon, aluminum, alloys thereof, or the like. Alternatively, they may be plated or deposited with nickel, chromium, or carbon.

The negative electrode mixture layer 21 includes a first layer 21a disposed on the side of the negative electrode current collector 22 and a second layer 21c disposed on the side of the separators 11. Further, as can be seen from FIG. 2, the second layer 21c is arranged so as to also cover the side surface of the first layer 21a. Accordingly, the peel strength of the second layer 21c can be increased more than the peel strength of the first layer 21a.

Each of the first layer 21a and the second layer 21c includes a negative electrode active material and a binder. In each layer, the negative electrode active material is bonded by a binder.

The negative electrode active material is preferably a graphite-based negative electrode active material, and any of natural graphite and artificial graphite may be used, but natural graphite is preferably used from the viewpoint of theoretical capacity and raw material cost. The particle shape is not particularly limited, but scaly graphite is preferred from the viewpoint of easy orientation and easy alignment of the expansion and contraction direction.

In addition, from the viewpoint of Li⁺ acceptability, the graphite-based negative electrode active material preferably has a mean particle diameter of about 2 μm to about 15 μm, for example, about 10 μm. In the present specification, the term “mean particle diameter” refers to a median diameter (d50) obtained by a laser-diffraction/scattering method.

As the binder, for example, styrene-butadiene rubber (SBR), polytetrafluoroethylene (PTFE), polyethylene oxide (PEO), acryl rubber (ACR), carboxymethyl cellulose (CMC), or the like can be used. CMC may also function as a thickener in the negative electrode mixture paste.

The content ratio of the binder in the first layer 21a and the content ratio of the binder in the second layer 21c are not particularly limited, but are preferably 1% by mass to 5% by mass. Among them, in the first embodiment, it is preferable that the content ratio of the second layer 21c is larger than that of the first layer 21a. For example, the content ratio of the second layer 21c is larger than that of the first layer 21a by 25% or more. Accordingly, the peel strength of the second layer 21c can be further increased more than the peel strength of the first layer 21a.

The weight ratio (basis weight ratio) of the first layer 21a to the second layer 21c is not particularly limited, but is preferably first layer:second layer=1:9 to 9.5:0.5, and more preferably first layer:second layer=6:4 to 9.5:0.5.

Further, in Embodiment 1, the first layer 21a is oriented such that the longitudinal direction of the active material 21b is the thickness direction of the negative electrode current collector 22. Here, “the thickness direction of the negative electrode current collector 22” is a direction inclined in the direction of 0 to 65 degrees, preferably 0 to 45 degrees with respect to the direction parallel to the thickness direction by an average value. As a result, strain occurring at the interface between the first layer 21a and the second layer 21c due to expansion and contraction of the graphite-based negative electrode active material can be suppressed, and thus excellent cycling properties can be obtained.

The orientation is known, but can be obtained by measuring the degree of orientation. For example, it can be obtained that the peak intensity I (110) derived from the (110) plane of the graphite crystals as measured by powder X-ray diffractometry (XRD) appears as a percentage of the ratio I (110)/I (002) of the peak intensity I (002) derived from the (002) plane. Such a peak-intensity can be measured using a conventionally known XRD device.

As described above, the first layer 21a in which the negative electrode active material 21b has a particular orientation can be produced by the following methods. First, a negative electrode mixture paste is prepared by a conventionally known method. The negative electrode mixture paste can be produced, for example, by kneading a graphite-based negative electrode active material and a binder in water.

Then, the negative electrode mixture paste is applied by a conventionally known method (for example, a die coating method). Then, by applying a magnetic field before the negative electrode mixture paste is dried (solidified), the graphite-based negative electrode active material contained in the negative electrode mixture paste can be oriented. When a magnetic field is applied to the negative electrode mixture paste prior to drying, the graphite-based negative electrode active material 21b contained in the negative electrode mixture paste is oriented such that the graphite layers are parallel to the magnetic field lines. Therefore, it is possible to control the orientation by adjusting the magnetic field lines in the orientation direction. The strength of the magnetic field and the time for applying the magnetic field are not particularly limited, and may be appropriately set so as to obtain a desired orientation. For example, the strength of the magnetic field can be set so that the magnetic flux density of the entire first layer 21a is about 500 mT to 1000 mT, and the duration of applying the magnetic field can be about 1 second to 20 seconds with respect to the entire first layer 21a.

### Negative Electrode (Form Example 2)

FIG. 3 is a schematic cross-sectional view showing an example of the configuration of the negative electrode 30 according to Embodiment 2. As can be seen from FIG. 3, the negative electrode 30 includes a negative electrode mixture layer 31 and a negative electrode current collector 22. A separator 11 is laminated on one surface side of the negative electrode mixture layer 31, and a negative electrode current collector 22 is laminated on the other surface side. The negative electrode current collector 22 can be considered in the same manner as in Form Example 1.

The negative electrode mixture layer 31 includes a first layer 21a disposed on the side of the negative electrode current collector 22 and a second layer 31a disposed on the side of the separators 11. Further, the second layer 31a is disposed so as to also cover the side surface of the first layer 21a. Accordingly, the peel strength of the second layer 31a can be increased more than the peel strength of the first layer 21a.

Each of the first layer 21a and the second layer 31a includes a negative electrode active material and a binder. The negative electrode active material is bonded by a binder. The material of the negative electrode active material and the binder can be considered in the same manner as in Form Example 1. However, in the embodiment example 2, unlike the embodiment example 1, the second layer 31a may have a lower binder content ratio than the first layer 21a. For example, the content ratio of the second layer 31a is smaller than that of the first layer 21a by 25% or more. As a result, the permeability of the electrolytic solution can be improved, and the reaction resistance of the battery cell can be reduced.

In the present embodiment, the orientation of the active material 21b in the first layer 21a can be considered in the same manner as in the above-described embodiment 1.

In Embodiment 2, the longitudinal direction of the active material 31b of the second layer 31a is oriented in a direction intersecting the thickness direction of the negative electrode current collector 22. Here, the “direction intersecting with the thickness direction of the negative electrode current collector 22” is a direction inclined at an average value of 35 to 90 degrees, preferably 45 to 90 degrees with respect to a direction parallel to the thickness direction. As a result, it is possible to further enhance the crack suppressing effect due to peeling, expansion, and contraction. The orientation method and the like can be considered in the same manner as in Form Example 1.

### Positive Electrode

In the positive electrode 40, a positive electrode mixture layer 41 including a positive electrode active material, a conductive auxiliary material, and a binder is fixed to one surface of a positive electrode current collector 42. The positive electrode active material may be, for example, LiCoO₂, LiNiO₂, LiNiₐCo_{b}O₂ (a+b=1, 0<a<1, 0<b<1), LiMnO₂, LiMn₂O₄, LiNiₐCo_{b}Mn_{c}O₂ (a+b+c=1, 0<a<1, 0<b<1, 0<c<1), LiFePO₄, etc. For example, acetylene black (AB) or the like can be used as the conductive auxiliary material, and for example, polyvinylidene fluoride (PVdF) or the like can be used as the binder.

The positive electrode current collector 42 is in the form of a foil, and examples of the material of the foil include stainless steel, nickel, chromium, gold, platinum, aluminum, iron, titanium, and zinc. These metal foils may be formed by plating or vapor-depositing nickel, chromium, carbon, or the like.

### Separator

The separator 11 is used to transmit Li⁺ and prevent the positive electrode 40 from contacting the negative electrode 20 (or the negative electrode 30) 0. The separator 11 is preferably a microporous membrane made of a polyolefin-based material from the viewpoint of mechanical strength and chemical stability. As the polyolefin-based material, for example, polyethylene (PE), polypropylene (PP), or the like can be used, and these materials can be combined and used.

### Nonaqueous Electrolyte

As the nonaqueous electrolyte, a nonaqueous electrolyte in which a lithium salt is dissolved in an aprotic solvent can be used. Examples of the aprotic solvents include cyclic carbonates such as ethylene carbonate (EC), propylene carbonate (PC), butylene carbonate (BC), γ-butyrolactone (yBL), and vinylene carbonate (VC), and linear carbonates such as dimethyl carbonate (DMC), ethyl methyl carbonate (EMC), and diethyl carbonate (DEC). For example, EC:EMC:DEC is 3:5:2 (by volume). As the lithium salt, for example, LiPF₆, LiBF₄, LiClO₄, LiAsF₆, Li(CF₃SO₂)₂N, Li(CF₃SO₃) or the like can be used. The salinity is, for example, on the order of 0.5 mol/L to 2.0 mol/L. The nonaqueous electrolyte may be in a gel form or a solid form.

Hereinafter, the present embodiment will be described in more detail with reference to Examples, but the present disclosure is not limited thereto.

### Preparation of Negative Electrode

Although the characteristics of the negative electrodes produced in the respective examples are shown in Table 1, the negative electrodes of the respective examples are basically produced as follows. Specifically, using a slurry containing an artificial graphite-based negative electrode active material and SBR, a two-layer coated electrode of DRY&WET (coating of the first layer→drying of the first layer→coating of the second layer→drying of the second layer) was prepared by a die coater. When the second layer is applied only to the upper surface of the first layer, the slurry discharge width of the die coater is 90 mm for the first layer, and the second layer is 90 mm for the second layer, and when the upper surface and the side surface of the first layer are coated for the second layer, the slurry discharge width of the die coater is 88 mm for the first layer and the second layer is 90 mm. (In addition to this embodiment, the first layer can be made from 38 mm to 148 mm, and the second layer can be made from 40 mm to 150 mm in the same manner.) The basis weight ratio between the first layer and the second layer was 9:1. The total basis weight, which is the sum of the first layer and the second layer, is set to 35 mg/cm². Note that the total basis weight can be configured in the same manner as long as the total basis weight is equal to or larger than 25 mg/cm². The content of the binder is shown in Table 1. In Table 1, an example in which the second layer is also disposed on the side surface is referred to as “∘”, and an example in which the second layer is not disposed on the side surface is referred to as “x”.

The orientation treatment was performed by a magnetic field as described above. In Table 1, the orientation treatment “present” of the first layer is the orientation described in the above active material 21b, and the orientation treatment “present” of the second layer is the orientation described in the active material 31b.

### Preparation of Positive Electrode

The positive electrode was evaluated using NCM623 (Ni:Co:Mn=6:2:3) as a positive electrode active material.

### Performance Evaluation

The cells prepared as described above were laminated batteries having 6000 mAh capacity, and the “initial resistance”, “resistance after durability”, and “crack after durability” were examined. The resistance was set to SOC 50% at an ambient temperature of 25° C., and was set to a resistance value calculated by a voltage-drop when discharged at 3 C (C-rate) for 10 seconds. The durability was 100 cycles of charge/discharge with 0.5 C between 0% and 100% SOC at 45° C. Incidentally, “crack after durability” was visually carried out, it was evaluated by the degree better, good, possible, impossible.

The results are shown in Table 1. In Table 1, the resistance increase rate is a value obtained by dividing the resistance after durability by the initial resistance.

TABLE 1

| | Layer 1 | | | Second layer | | | | | | | |
|---|---|---|---|---|---|---|---|---|---|---|---|
| | Average | | | | Average | | | | | | |
| | particle | | | | particle | | | | | | |
| | diameter | | | | diameter | | | | | | |
| | (μm) of | | | | (μm) of | | | | | | |
| | the | | | Layout | the | | | Evaluation results | | | |
| | negative | | Binder | on the | negative | | Binder | | Resistance | | |
| | electrode | | content | side of | electrode | | content | Initial | after | Rate of | |
| | active | Orientation | (% by | the first | active | Orientation | (% by | resistance | durability | resistance | Post-durability |
| | material | treatment | mass) | layer | material | treatment | mass) | (Ω) | (Ω) | increase | crack |
| Comparative | 10 | None | 2.0 | No | | | | 165 | 198 | 1.20 | Good |
| Example 1 | | | | second | | | | | | | |
| | | | | layer | | | | | | | |
| Comparative | 10 | Y | 2.0 | x | 10 | None | 2.0 | 100 | 175 | 1.75 | Not possible |
| Example 2 | | | | | | | | | | | |
| Comparative | 10 | Y | 2.0 | x | 3 | None | 2.0 | 92 | 170 | 1.85 | Not possible |
| Example 3 | | | | | | | | | | | |
| Example 1 | 10 | Y | 2.0 | ∘ | 3 | None | 2.0 | 93 | 130 | 1.40 | Yes |
| Example 2 | 10 | Y | 2.0 | ∘ | 3 | None | 2.5 | 99 | 119 | 1.20 | Good |
| Example 3 | 10 | Y | 2.0 | ∘ | 3 | Y | 2.5 | 100 | 120 | 1.20 | Good |
| Example 4 | 10 | Y | 2.0 | ∘ | 3 | Y | 2.0 | 96 | 115 | 1.20 | Good |
| Example 5 | 10 | Y | 2.0 | ∘ | 3 | Y | 1.5 | 82 | 98 | 1.20 | Good |

### Results

In Comparative Example 2 and Comparative Example 3 in which the second layer was provided but the second layer was not provided on the side surface of the first layer, cracks occurred after durability and the resistance increase rate was also large as compared with Comparative Example 1 in which only the first layer was provided.

In Example 1, since the second layer is also provided on the side surface of the first layer, the resistance increase rate is lower than in Comparative Example 2 and Comparative Example 3, and the crack after the durability is also improved.
In Example 2, the resistance increase rate is further lowered by increasing the ratio of the binder of the second layer as compared with Example 1, and the crack after durability is also improved.
In Example 3-5, the alignment treatment of the second layer was also performed, so that the resistance increase rate was as low as in Example 2, and the crack after the durability was also improved. In particular, in Example 4 and Example 5, the content ratio of the binder could be reduced, and the initial resistance and the resistance after durability could also be reduced.

Although the present embodiment and the embodiment have been described above, it should be understood that the embodiment and the embodiment disclosed herein are illustrative and not restrictive in all respects. The scope of the present disclosure is set forth by the claims rather than by the above description, and is intended to include all modifications within the meaning and scope equivalent to the claims.

What is claimed is:

1. A negative electrode for a secondary battery, the negative electrode including a negative electrode current collector and a negative electrode mixture layer laminated on the negative electrode current collector and containing an active material, the negative electrode comprising:
a first layer; and
a second layer laminated so as to cover a layer surface of the first layer and a side surface of the first layer, wherein:
the first layer is oriented such that a longitudinal direction of the active material contained in the first layer is directed in a thickness direction of the negative electrode current collector; and
the second layer has a higher peel strength than that of the first layer.

2. The negative electrode according to claim 1, wherein the second layer is oriented such that a longitudinal direction of the active material contained in the second layer is directed in a direction intersecting the thickness direction of the negative electrode current collector.

3. The negative electrode according to claim 2, wherein the second layer contains a binder in an amount less than that of the first layer by 25% or more.
